(19) United States
(12) Patent Application Publication
(10) Pub. No.: US 2013/0320954 A1
(43) Pub. Date: Dec. 5, 2013

(54) SWITCHED-MODE VOLTAGE CONVERTER WITH ENERGY RECOVERY SYSTEM

(71) Applicant: FAIRCHILD SEMICONDUCTOR CORPORATION, San Jose, CA (US)

(72) Inventors: Peter Capofreddi, Pine Grove Mills, PA (US); Timothy Alan Dhuyvetter, Arnold, CA (US); Nicholas Stinson, Gorham, ME (US)

(73) Assignee: Fairchild Semiconductor Corporation, San Jose, CA (US)

(21) Appl. No.: 13/887,516

(22) Filed: May 6, 2013

Related U.S. Application Data
(60) Provisional application No. 61/654,223, filed on Jun. 1, 2012.
(60) Provisional application No. 61/654,242, filed on Jun. 1, 2012.

(51) Int. Cl. G05F 3/08

(52) U.S. Cl. CPC G05F 3/08
USPC 323/311

(57) ABSTRACT

Devices, systems and methods are provided for a switched-mode voltage converter system with energy recovery. The device may include a first voltage converter circuit including a boost voltage node and an output voltage port coupled to a load. The first voltage converter circuit configured to deliver energy from the boost voltage node to the load in a first mode, and to deliver energy from the load to the boost voltage node in a second mode. The device may also include a second voltage converter circuit coupled to an energy source and to the boost voltage node, the second voltage converter circuit configured to convert a first voltage associated with the energy source to a second voltage associated with the boost voltage node.

### CROSS REFERENCE TO RELATED APPLICATIONS

This application claims the benefit of U.S. provisional application Ser. No. 61/654,223, filed Jun. 1, 2012, and U.S. provisional application Ser. No. 61/654,242 filed Jun. 1, 2012, which are incorporated fully herein by reference.

### FIELD

The present disclosure relates to a switched-mode voltage converter system, and more particularly, to a switched-mode voltage converter system with energy recovery.

### BACKGROUND

Switched mode voltage converters (or DC/DC converters) are generally configured to receive a source voltage and generate an output voltage as a transformed version of a control input voltage. Many configurations of DC/DC converters exist including Buck converters, boost converters, Buck/boost converters and flyback converters. These voltage converters typically receive energy from a power source and employ switches and energy storage elements to convert that energy to a desired output voltage using modulated switching frequencies and/or pulse widths to control the output voltage of the converter. Some portion of the energy that is drawn from the power supply may be wasted during the operation of the converter resulting in decreased efficiency and increased cost.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a top level block diagram consistent with various embodiments of the present disclosure;

FIG. 2 illustrates a circuit diagram consistent with an exemplary embodiment of the present disclosure;

FIG. 3 illustrates circuit operations consistent with another exemplary embodiment of the present disclosure;

FIG. 4 illustrates a circuit diagram consistent with another exemplary embodiment of the present disclosure;

FIG. 5 illustrates a circuit diagram consistent with another exemplary embodiment of the present disclosure;

FIG. 6 illustrates a circuit diagram consistent with another exemplary embodiment of the present disclosure; and

FIG. 7 illustrates a flowchart of operations consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, the present disclosure provides a device, system and method for driving a load with energy recovery, wherein the load has a reactive component that is capacitive. The device may include a switched-mode voltage converter which provides an output voltage to the load that is based on a control signal. The output voltage may be, for example, an amplified version of the control signal. Energy released from the capacitive load, as part of a charge/discharge cycle, may be recovered and stored in a second capacitor, a boost capacitor which may be coupled to the converter. Energy losses in the converter and dissipation in the load may be replenished from an energy source, for example a battery, which further charges the boost capacitor through a second converter which may be a boost converter.

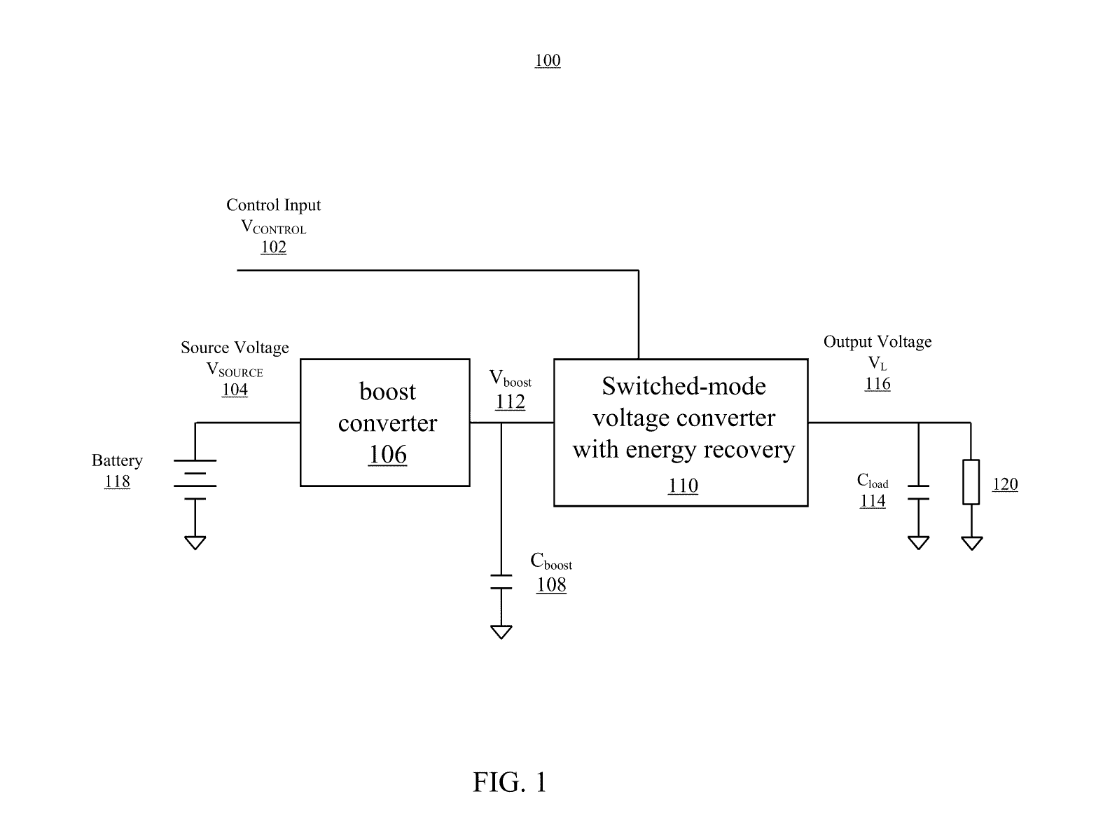

FIG. 1 illustrates a top level block diagram 100 consistent with various embodiments of the present disclosure. As a general overview, the system 100 includes an energy source 118, such as, for example a battery, configured to provide a source voltage Vsource 104, a boost converter 106, a boost capacitor 108 and a switched-mode voltage converter configured for energy recovery 110. The switched-mode voltage converter 110 may be any suitable type of switched mode converter such as a boost converter, a buck converter or combination buck-boost converter or inverting versions of buck and/or boost converters. Switched-mode voltage converter 110 provides an output voltage V_{L} 116 to the load which may include a reactive element C_{LOAD} 114 that is capacitive, as well as a dissipative element 120. The output voltage is based on a control signal Vcontrol 102. The output voltage 116 may track the control signal 102. For example, the output voltage 116 may be an amplified version of the control signal 102 or may be otherwise proportional to the control signal 102.

Switched mode converters generally receive energy from a power source and employ switches and energy storage elements to convert that energy to the desired output voltage using modulated switching frequencies and/or pulse widths to control the conversion ratio of the converter. Embodiments of the present disclosure, however, provide for the converter to receive at least a portion of its energy from an energy recovery process associated with the load. The reactive element of the load that is capacitive, C_{LOAD} 114, may, for example, be a piezoelectric speaker or a transducer (including a transducer for tactile feedback). C_{LOAD} 114 may alternately store and release energy as part of a charge/discharge cycle in response to variations in the output voltage 116, which varies in proportion to the control voltage. The released energy from C_{LOAD} 114 may be recovered and stored in boost capacitor C_{BOOST} 108 to provide energy to the converter 110 for subsequent operation. Energy losses in the converter 110 and power dissipation in the dissipative element of the load 120 may be replenished from energy source 118, for example a battery providing source voltage Vsource 104, which can augment the charge on the boost capacitor 108, for example when the voltage on the boost capacitor drops below a pre-defined threshold. A boost converter 106 may be used to convert the voltage from the energy source 118, i.e., Vsource 104, to a suitable voltage range V_{BOOST} 112 for the converter 110. V_{BOOST} 112 is typically larger than Vsource, and in some embodiments V_{BOOST} may have a nominal value of 35 volts while Vsource may have a nominal value of 3.5 volts. Additionally, C_{BOOST} 108 is typically larger than C_{LOAD} 114, and in some embodiments C_{BOOST} may have a nominal value of 10 μF while C_{LOAD} may have a nominal value of 1 μF.

Advantageously, this two stage approach, employing a separate boost converter for energy replenishment, allows power transfers to and from the load to be performed at higher voltages (compared to the voltage supplied by the battery) and therefore lower currents. Additionally, the boost converter is called on to deliver only the power needed to replenish energy losses in the system and therefore may operate at lower power levels.

In some embodiments, the boost converter 106 and the switched-mode voltage converter 110 may be incorporated on an integrated circuit (IC) and the boost capacitor may be coupled to a boost port provided on the IC.

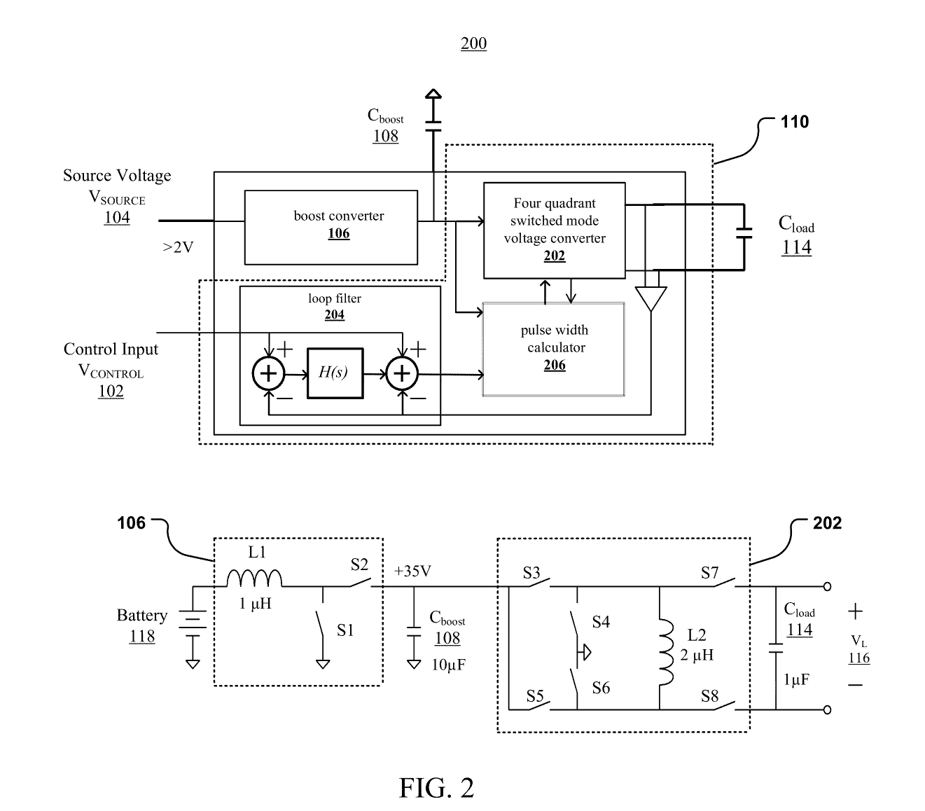

FIG. 2 illustrates a circuit diagram 200 consistent with an exemplary embodiment of the present disclosure. This figure expands upon FIG. 1 and provides additional detail. For example, in this embodiment, the switched-mode voltage converter 110 is shown, in the upper portion of the figure, to further include a four quadrant switched-mode voltage converter 202, a pulse width calculator 206 and a loop filter 204. The lower portion of the figure illustrates example circuit component configurations for the boost converter 106 and the four quadrant switched-mode voltage converter 202. The term “four quadrant converter,” as used in the present disclosure, refers to a voltage converter that provides an output voltage that can be positive or negative as well as an output current that can be positive or negative.

In operation the boost converter 106 may convert the voltage from the energy source 118 (e.g., a battery) from a first lower value, for example in the approximate range of 2 to 5 volts, to a second higher value, for example in the approximate range of 30 to 40 volts. This may be accomplished through the use of an energy storage inductor L1 and a switching network S1 and S2. The switching modulation of S1 and S2 may be adjusted to provide the desired voltage at the boost capacitor C_{Boost} 108. In some embodiments, L1 may have an inductance with a nominal value of 1 μH.

In operation the four quadrant switched-mode voltage converter 202 may operate from the supply voltage provided at the boost capacitor C_{Boost} 108 and may provide an output voltage V_{L} 116 to the load that is based on an input control signal Vcontrol 102. The output voltage 116 may track the control signal 102. For example, the output voltage 116 may be an amplified or attenuated version of the control signal 102. This may be accomplished through the use of an energy storage inductor L2 and a switching network S3 through S8. The switching modulation of switches S3-S8 may be adjusted to provide the desired output voltage. In some embodiments, L2 may have an inductance with a nominal value of 2 μH. The modulation or pulse width of the switching network S3-S8, may be controlled by pulse width calculator 206. In some embodiments, the pulse width calculator 206 may be a quadratic pulse width calculator, the operations of which are described in greater detail in a previously filed provisional patent application Ser. No. 61/654,242, filed Jun. 1, 2012. Loop filter 204 amplifies the error signal, or difference between the output voltage 116 and the control signal voltage 102, and performs filtering operations that improve the stability of the control loop. In some embodiments, the loop filter may be modeled by the following transfer function:

$$H ( s ) = \frac{A {ω}_{p}}{s + {ω}_{p}} ,$$

which is a low pass filter with a cut-off frequency of ωₚ where nominal values for the parameters may be A=10 (20 dB) and, ωₚ=2π(10 kHz). The filtered error signal is then provided to the pulse width calculator 206 which modulates the switching network S3-S8 to adjust the gain of the converter 202.

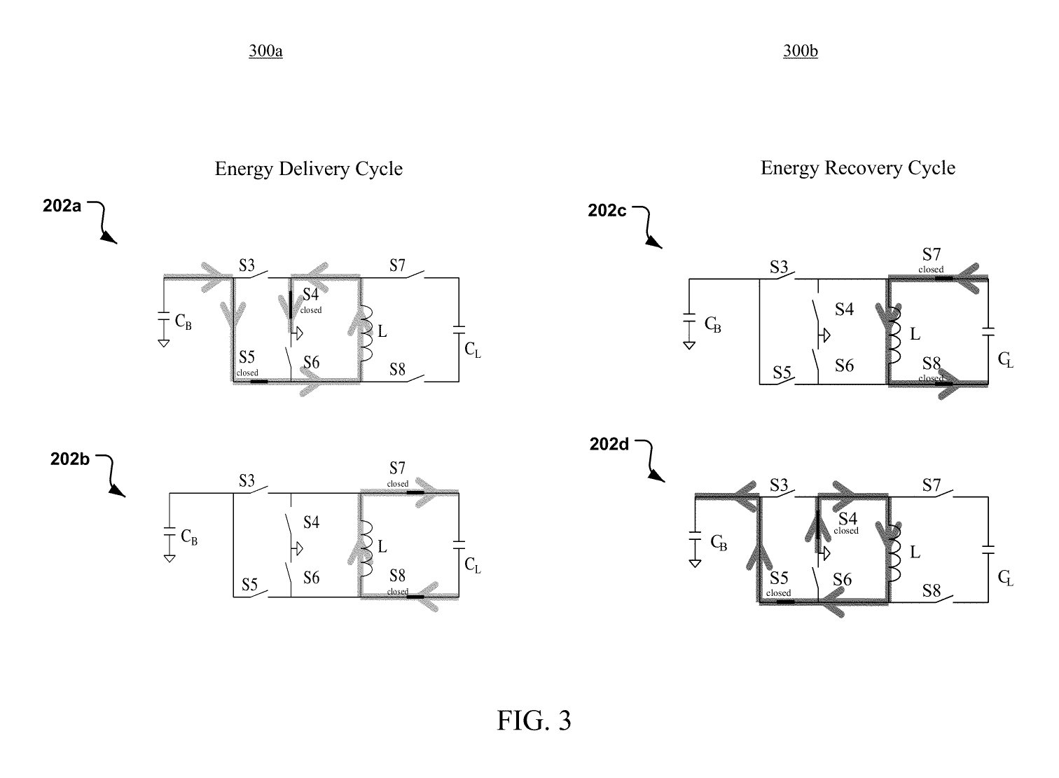

FIG. 3 illustrates circuit operations 300a and 300b consistent with another exemplary embodiment of the present disclosure. The voltage converter 110 may operate in one of two modes. The first mode is associated with energy delivery to the load and the second mode is associated with energy recovery from the load. Operation 300a illustrates two stages of an energy delivery cycle (first mode of operation) of the four quadrant switched-mode voltage converter 202. In the first stage 202a, switches S4 and S5 are closed while switches S3, S6, S7 and S8 are open. In this configuration current flows from the boost capacitor through the inductor allowing energy to be delivered from the capacitor for storage in the inductor. In the second stage 202b, switches S3, S4, S5 and S6 are open while switches S7 and S8 are closed permitting current to flow from the inductor to the load.

Operation 300b illustrates two stages of an energy recovery cycle (second mode of operation) of the four quadrant switched-mode voltage converter 202. In the first stage 202c, switches S7 and S8 are closed while switches S3, S4, S5 and S6 are open. In this configuration current flows from the load back through the inductor. In the second stage 202d, switches S4 and S5 are closed while switches S3, S6, S7 and S8 are open permitting current to flow back from the inductor to the boost capacitor for storage until a subsequent delivery cycle.

The transition between energy delivery mode and energy recovery mode may be based on a comparison of the output voltage 116 to the control voltage 102. For example, if

V_{L}<k Vcontrol,

where k is a pre-determined proportionality constant, then the converter may operate in energy delivery mode, otherwise the converter may operate in energy recovery mode.

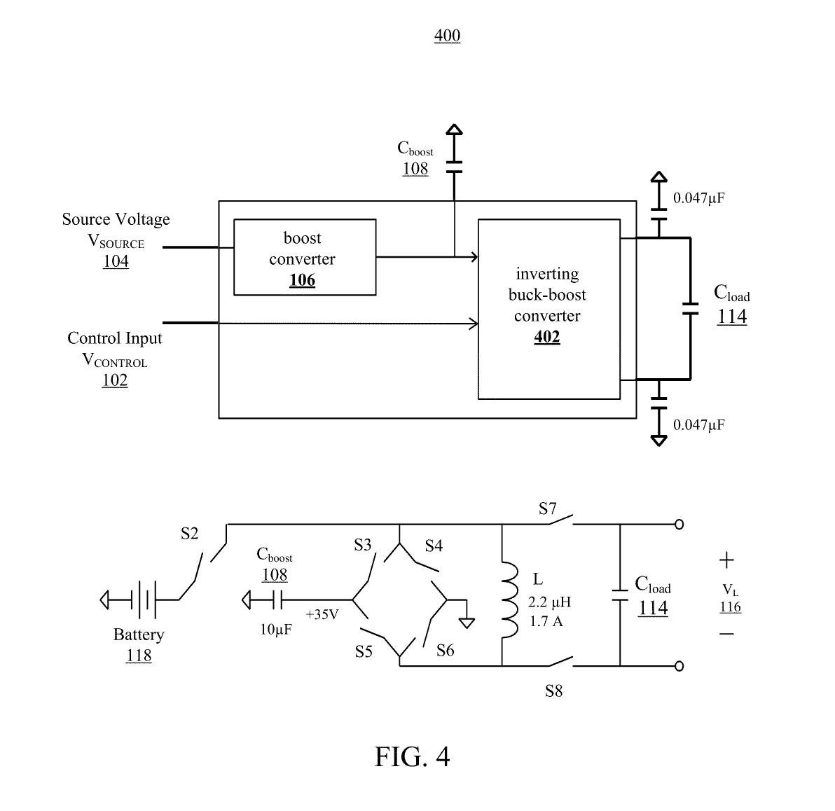

FIG. 4 illustrates a circuit diagram 400 consistent with another exemplary embodiment of the present disclosure. In this alternative embodiment, the switched-mode voltage converter 110 may be an inverting buck-boost converter 402 which may provide an output voltage covering a positive and negative voltage range. In this configuration, L, S3 and S6 are shared by the boost converter 106 and the inverting buck-boost converter 402. In some embodiments, the output voltage range may nominally include +30 volts to −30 volts and the inductor may have a nominal value of 2.2 μH.

The boost converter 106 may share a common inductor with the switched-mode voltage converter 402. Because inductors are typically the largest and most expensive components in the system there is an advantage to sharing a single inductor between the two converters 106 and 402. The shared common inductor may be used to deliver energy from the energy source to the boost capacitor, to delivery energy from the boost capacitor to the load, and to recover energy from the load to the boost capacitor. The duty cycle allocated to each of these 3 operations, however, will be shorter resulting in a larger inductor current and greater power loss. Additionally, when transitioning from one of the three operations in a first cycle to a different operation in a subsequent cycle, energy remaining in the inductor at the end of the first cycle may adversely affects performance in the following cycle.

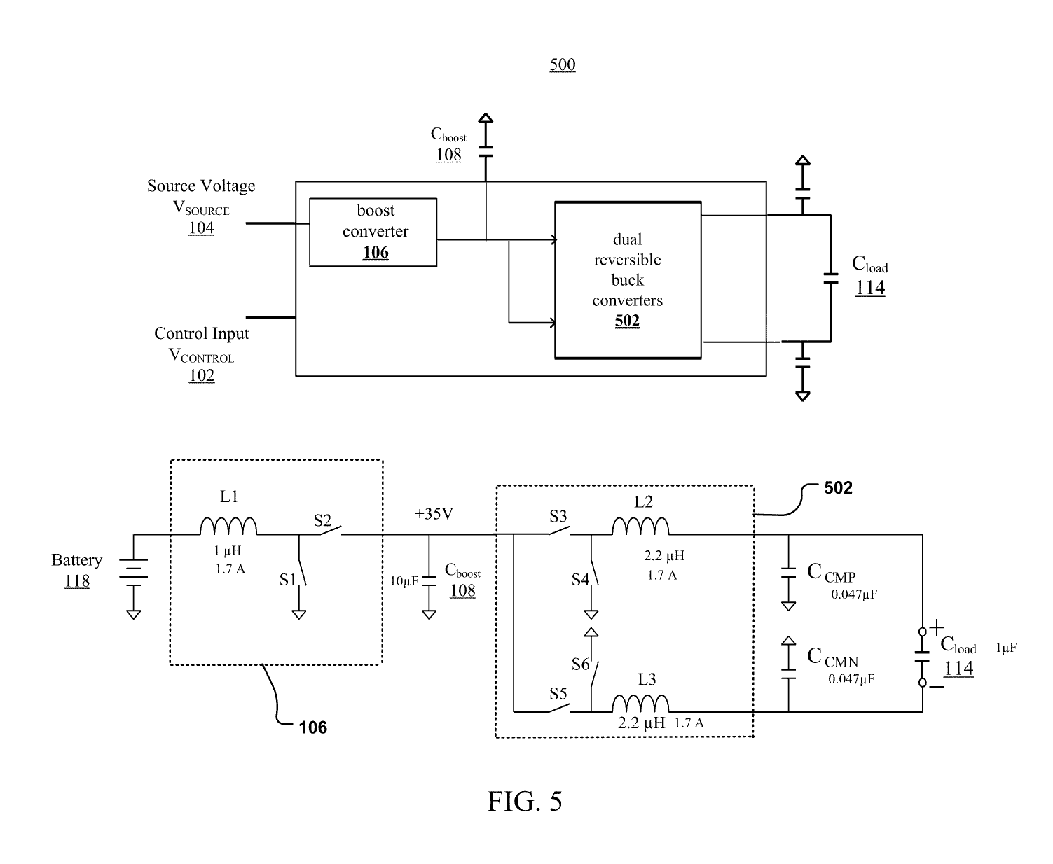

FIG. 5 illustrates a circuit diagram 500 consistent with another exemplary embodiment of the present disclosure. In this alternative embodiment, the switched-mode voltage converter 110 may include a pair of reversible buck converters 502. Each of the reversible buck converters may be configured to operate in two modes: one in which they function as a buck converter delivering energy from the boost capacitor to the load, and a second in which they function as a boost converter recovering energy from the load to the boost capacitor. The two reversible buck converters 502 generate a differential voltage which may be either positive or negative.

In the buck-boost configuration shown in the embodiment of FIG. 2, both terminals of the inductor L2 are connected to the boost voltage for a time duration t1 and then both terminals are connected to the load for a time duration t2. In the dual reversible buck converter configuration shown in FIG. 5, one terminal of each of inductors L2 and L3 remain connected to the load. There are two advantages to this configuration: (1) elimination of the switches between inductor and load reduces losses and improves efficiency, and (2) the reduced peak currents required in the buck configuration reduce losses and improve efficiency. The primary disadvantage of this embodiment is the increased cost and area associated with the use of three separate inductors.

Capacitors Ccmp and Ccmn are provided to increase stability at the common mode output. In some embodiments, these capacitors may have nominal values of 0.047 μF.

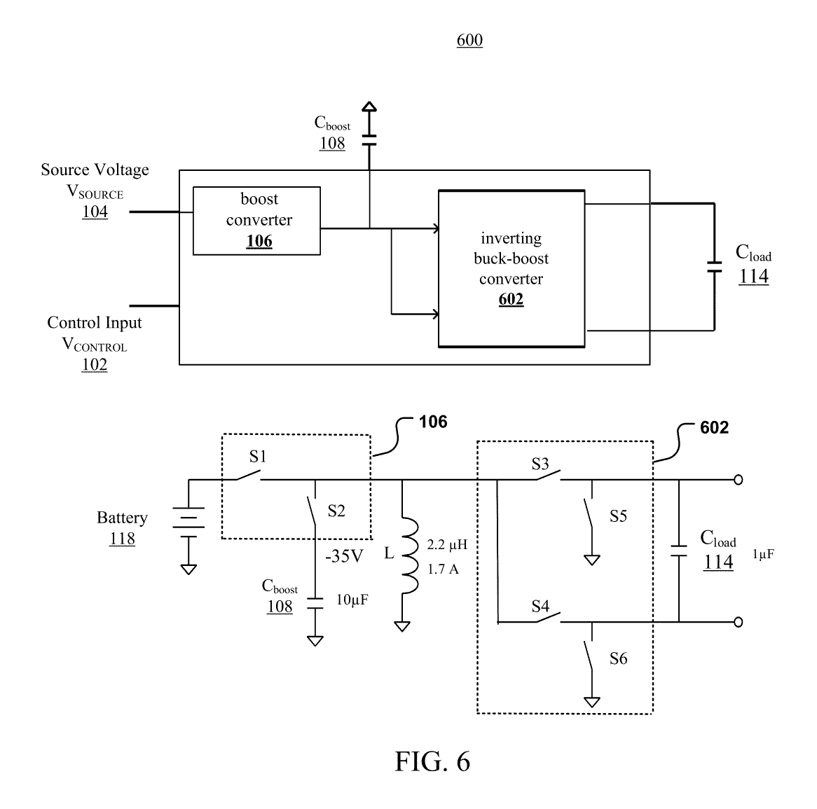

FIG. 6 illustrates a circuit diagram 600 consistent with another exemplary embodiment of the present disclosure. Shown here is yet another embodiment in which the boost converter 106 may include an inverting boost converter and the switched-mode voltage converter 110 may include an inverting buck-boost converter 602. The boost converter 106 may share a common inductor with the switched-mode voltage converter 602.

In the inverting buck-boost configuration shown in the embodiment of FIG. 4, both terminals of the inductor are connected to the boost voltage for a time duration t1 and then both terminals are connected to the load for a time duration t2. Switches are therefore required on both terminals of the inductor, resulting in increased loss. In the inverting buck-boost configuration shown in the embodiment of FIG. 6, one terminal of the inductor remains connected to ground. This reduces the switch losses by approximately a factor of two. The primary disadvantage of this embodiment, however, is that the non-grounded terminal of the inductor swing from a negative to a positive voltage, which may require (1) switches with higher breakdown voltage, (2) active substrate biasing, and (3) additional drive circuits to control the switches.

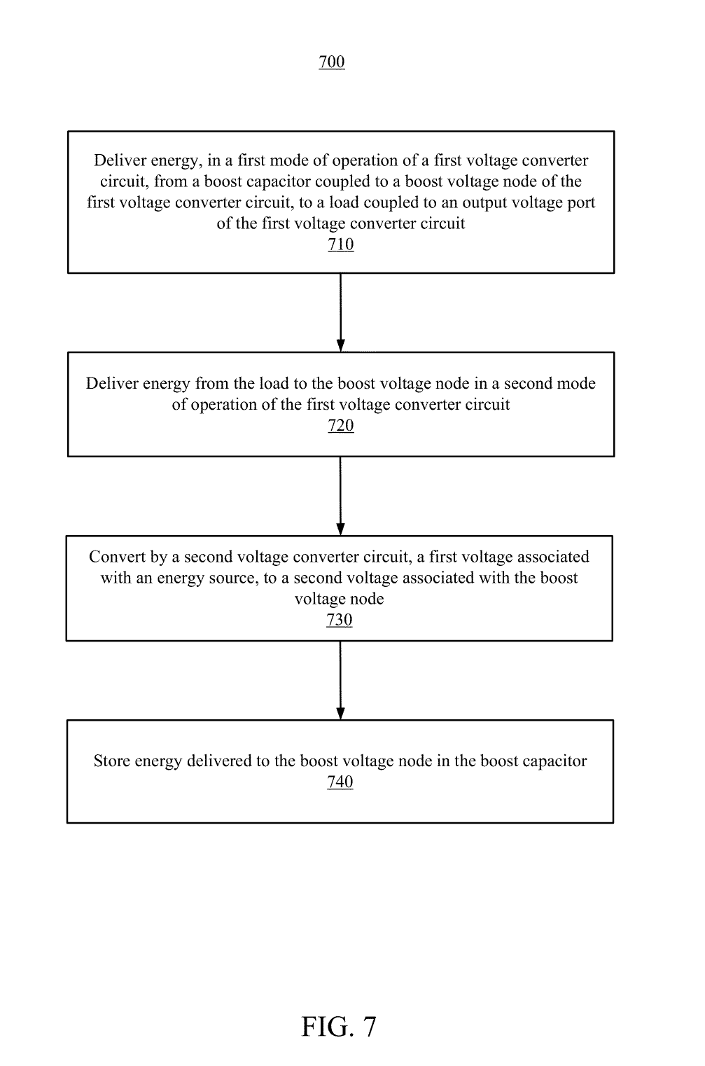

FIG. 7 illustrates a flowchart of operations 700 consistent with various embodiments of the present disclosure for recovering energy from a voltage converter device. At operation 710, energy is delivered, in a first mode of operation of a first voltage converter circuit, from a boost capacitor coupled to a boost voltage node of the first voltage converter circuit, to a load coupled to an output voltage port of the first voltage converter circuit. At operation 720, energy is delivered, from the load to the boost voltage node in a second mode of operation of the first voltage converter circuit. At operation 730, a first voltage associated with an energy source is converted, by a second voltage converter circuit, to a second voltage associated with the boost voltage node. At operation 740, energy delivered to the boost voltage node is stored in the boost capacitor.

As used herein, use of the term “nominal” or “nominally” when referring to an amount means a designated or theoretical amount that may vary from the actual amount.

The term “switches” may be embodied as MOSFET switches (e.g. individual NMOS and PMOS elements), BJT switches, diodes and/or other switching circuits known in the art. In addition, “circuitry” or “circuit”, as used in any embodiment herein, may include, for example, singly or in any combination, hardwired circuitry, programmable circuitry, state machine circuitry, and/or circuitry that is included in a larger system, for example, elements that may be included in an integrated circuit.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Thus, the present disclosure provides devices, systems and methods for recovering energy from a load. According to one aspect there is provided a voltage converter device. The device may include a first voltage converter circuit including a boost voltage node and an output voltage port, the output voltage port coupled to a load, the first voltage converter circuit configured to deliver energy from the boost voltage node to the load in a first mode, the first voltage converter circuit configured to deliver energy from the load to the boost voltage node in a second mode. The device of this example may also include a second voltage converter circuit coupled to an energy source and to the boost voltage node, the second voltage converter circuit configured to convert a first voltage associated with the energy source to a second voltage associated with the boost voltage node. The device of this example may further include a boost capacitor coupled to the boost voltage node, the boost capacitor configured to store the energy delivered from the load.

According to another aspect there is provided a method. The method may include delivering energy, in a first mode of operation of a first voltage converter circuit, from a boost capacitor coupled to a boost voltage node of the first voltage converter circuit, to a load coupled to an output voltage port of the first voltage converter circuit. The method of this example may also include delivering energy from the load to the boost voltage node in a second mode of operation of the first voltage converter circuit. The method of this example may further include converting, by a second voltage converter circuit, a first voltage associated with an energy source, to a second voltage associated with the boost voltage node. The method of this example may further include storing energy delivered to the boost voltage node in the boost capacitor.

According to another aspect there is provided a power supply system. The system may include a switched-mode power supply circuit configured to generate a DC output voltage from a DC input voltage. The switched-mode power supply circuit of this example may include a first voltage converter circuit including a boost voltage node and an output voltage port, the output voltage port coupled to a load, the first voltage converter circuit configured to deliver energy from the boost voltage node to the load at the DC output voltage in a first mode, the first voltage converter circuit configured to deliver energy from the load to the boost voltage node in a second mode. The switched-mode power supply circuit of this example may also include a second voltage converter circuit coupled to an energy source and to the boost voltage node, the second voltage converter circuit configured to convert a first voltage associated with the energy source to a second voltage associated with the boost voltage node. The switched-mode power supply circuit of this example may further include a boost capacitor coupled to the boost voltage node, the boost capacitor configured to store the energy delivered from the load.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A voltage converter device comprising:
a first voltage converter circuit comprising a boost voltage node and an output voltage port, said output voltage port coupled to a load, said first voltage converter circuit configured to deliver energy from said boost voltage node to said load in a first mode, said first voltage converter circuit configured to deliver energy from said load to said boost voltage node in a second mode; and
a second voltage converter circuit coupled to an energy source and to said boost voltage node, said second voltage converter circuit configured to convert a first voltage associated with said energy source to a second voltage associated with said boost voltage node.

2. The device of claim 1 further comprising a control signal input port configured to receive a control signal, said device further configured to produce an output voltage at said output voltage port, said output voltage based on said control signal.

3. The device of claim 1, wherein said first voltage converter circuit is configured as an inverting buck-boost converter.

4. The device of claim 1, wherein said first voltage converter circuit further comprises dual reversible buck converters.

5. The device of claim 1, wherein said energy source is a battery.

6. The device of claim 1, wherein said load is a piezoelectric transducer.

7. The device of claim 1, wherein said second voltage is greater than said first voltage.

8. The device of claim 1, further comprising a boost capacitor coupled to said boost voltage node, said boost capacitor configured to store said energy delivered from said load, wherein the capacitance of said boost capacitor is greater than the capacitance of said load.

9. A method for recovering energy from a load, said method comprising:
delivering energy, in a first mode of operation of a first voltage converter circuit, from a boost capacitor coupled to a boost voltage node of said first voltage converter circuit, to a load coupled to an output voltage port of said first voltage converter circuit;
delivering energy from said load to said boost voltage node in a second mode of operation of said first voltage converter circuit;
converting, by a second voltage converter circuit, a first voltage associated with an energy source, to a second voltage associated with said boost voltage node; and
storing energy delivered to said boost voltage node in said boost capacitor.

10. The method of claim 9, further comprising receiving a control signal at an input port of said device and producing an output voltage at said output voltage port, said output voltage based on said control signal.

11. The method of claim 9, wherein said first voltage converter circuit is configured as an inverting buck-boost converter.

12. The method of claim 9, wherein said first voltage converter circuit comprises dual reversible buck converters.

13. The method of claim 9, wherein said energy source is a battery.

14. The method of claim 9, wherein said load is a piezoelectric transducer.

15. The method of claim 9, wherein said second voltage is greater than said first voltage.

16. The method of claim 9, wherein the capacitance of said boost capacitor is greater than the capacitance of said load.

17. A power supply system comprising:
a switched-mode power supply circuit configured to generate a DC output voltage from a DC input voltage, said switched-mode power supply circuit comprising:
a first voltage converter circuit comprising a boost voltage node and an output voltage port, said output voltage port coupled to a load, said first voltage converter circuit configured to deliver energy from said boost voltage node to said load at said DC output voltage in a first mode, said first voltage converter circuit configured to deliver energy from said load to said boost voltage node in a second mode;
a second voltage converter circuit coupled to an energy source and to said boost voltage node, said second voltage converter circuit configured to convert a first voltage associated with said energy source to a second voltage associated with said boost voltage node; and
a boost capacitor coupled to said boost voltage node, said boost capacitor configured to store said energy delivered from said load.

18. The system of claim 17, wherein said first voltage converter circuit is configured as an inverting buck-boost converter.

19. The system of claim 17, wherein said first voltage converter circuit further comprises dual reversible buck converters.

20. The system of claim 17, wherein said energy source is a battery.

21. The system of claim 17, wherein said load is a piezoelectric transducer.

22. The system of claim 17, wherein said second voltage is greater than said first voltage.

23. The system of claim 17, wherein the capacitance of said boost capacitor is greater than the capacitance of said load.
